(19) United States
(12) Patent Application Publication
(10) Pub. No.: US 2010/0245312 A1
(43) Pub. Date: Sep. 30, 2010

(54) ELECTRO-OPTICAL APPARATUS DRIVING CIRCUIT, ELECTRO-OPTICAL APPARATUS, AND ELECTRONIC DEVICE

(75) Inventor: Katsunori YAMAZAKI, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/725,494

(22) Filed: Mar. 17, 2010

(30) Foreign Application Priority Data
Mar. 25, 2009 (JP) 2009-074179

(51) Int. Cl. G06F 3/038; G09G 3/20

(52) U.S. Cl. 345/208; 345/55

(57) ABSTRACT

An electro-optical apparatus driving circuit that drives an electro-optical apparatus including multiple rows of scanning lines, multiple columns of data lines, and multiple pixels provided corresponding to the locations at which the scanning lines and the data lines intersect. The driving circuit includes: a scanning line main driving circuit, provided on at least one end of the multiple rows of scanning lines, that selects the multiple rows of scanning lines in a predetermined order and applies scanning signals thereto; and a scanning line supplementary driving circuit, provided on at least one end of the both ends of the multiple scanning lines, that operates in response to a scanning signal being applied by the scanning line main driving circuit to a scanning line selected before or after the selection of a certain scanning line, the scanning line supplementary driving circuit applying a supplementary signal for shaping the waveform of the scanning signal to the certain scanning line during an interval in which the certain scanning line is selected and the scanning signal is applied thereto by the scanning line main driving circuit.

### BACKGROUND

1. Technical Field

The present invention relates to an electro-optical apparatus driving circuit, an electro-optical apparatus, and an electronic device.

2. Related Art

Electro-optical apparatuses such as liquid crystal apparatuses include multiple rows of scanning lines, multiple columns of data lines, and multiple pixels provided in correspondence with the locations at which the scanning lines and data lines intersect. In such apparatuses, the optical state of each of the pixels is changed by supplying, to each of the pixels corresponding to a selected scanning line and via the data lines, data signals in accordance with the tone of each of the pixels. Most past electro-optical apparatuses employ unilateral driving, whereby a scanning line driving circuit for driving the scanning lines provided only on one end of the scanning lines, and the scanning lines are driven from that side.

However, because scanning lines exhibit a small amount of resistance and parasitic capacitance, when unilaterally driving scanning lines, the waveform of the signals dulls as the signals progress through the scanning lines from the end on which the scanning line driving circuit is provided (the driving end) toward the end on which the scanning line driving circuit is not provided (the terminus). Accordingly, the pixel brightnesses differ slightly from pixel to pixel or crosstalk occurs, and the quality of the display decreases as a result. JP-A-11-295696 discloses a bilaterally-driven electro-optical apparatus that attempts to improve display quality by providing scanning line driving circuits on both ends of the scanning lines and the scanning lines are driven from both sides.

Meanwhile, JP-A-2006-162828 discloses a technique for realizing a reduction in the cost and size of a bilaterally-driven electro-optical apparatus. Specifically, in JP-A-2006-162828, the dulling of waveforms is corrected by providing, at one end of the scanning lines, a scanning line main driving circuit that drives the scanning lines and providing, on the other end of the scanning lines, a scanning line supplementary driving circuit which connects the scanning lines to the selected voltage supply line when a selection voltage (voltage for selecting scanning lines) is applied by the scanning line main driving circuit.

Meanwhile, in recent years, there is demand for the costs of electro-optical apparatuses to be reduced, and thus it is necessary to manufacture such electro-optical apparatuses at the lowest cost possible. There is a particularly heavy demand for cost reduction in the compact electro-optical apparatuses employed in mobile electronic devices. Such a reduction in costs can of course be achieved if the circuitry of such an electro-optical apparatus is simplified to the greatest extent possible without paying any attention to the display quality thereof. However, because it is necessary to maintain a certain high level of display quality, it is not acceptable to just simplify the circuitry.

Employing the technique disclosed in the aforementioned JP-A-2006-162828 can be considered as being capable of reducing cost reduction in an electro-optical apparatus while also maintaining this certain high level of display quality. However, with the technique disclosed in JP-A-2006-162828, the scanning line supplementary driving circuit is configured using a differentiating circuit, a logical circuit, and an n-channel transistor and a p-channel transistor, and thus further improvements thereupon can be thought of as necessary to realize a reduction in costs.

### SUMMARY

An advantage of some aspects of the invention is to provide an electro-optical apparatus driving circuit, an electro-optical apparatus, and an electronic device provided with the circuit or apparatus, that are capable of realizing high display quality at a low cost.

An electro-optical apparatus driving circuit according to a first aspect of the invention drives an electro-optical apparatus including multiple rows of scanning lines, multiple columns of data lines, and multiple pixels provided corresponding to the locations at which the scanning lines and the data lines intersect. The driving circuit includes: a scanning line main driving circuit, provided on at least one end of the multiple rows of scanning lines, that selects the multiple rows of scanning lines in a predetermined order and applies scanning signals thereto; and a scanning line supplementary driving circuit, provided on at least one end of the both ends of the multiple scanning lines, that operates in response to a scanning signal being applied by the scanning line main driving circuit to a scanning line selected before or after the selection of a certain scanning line, the scanning line supplementary driving circuit applying a supplementary signal for shaping the waveform of the scanning signal to the certain scanning line during an interval in which the certain scanning line is selected and the scanning signal is applied thereto by the scanning line main driving circuit.

According to this aspect of the invention, when a scanning signal is applied by the scanning line main driving circuit to a certain scanning line among the multiple rows of scanning lines, a supplementary signal for shaping the scanning signal is applied to the certain scanning line by the scanning line supplementary driving circuit, which operates in response to the application of a scanning signal applied to another scanning line selected before or after the selection of the certain scanning line. Accordingly, the occurrence of variance in the brightnesses of pixels, crosstalk, and so on can be prevented, making it possible to realize a high display quality. Furthermore, because the scanning line supplementary driving circuit operates in response to the scanning signal applied to the other scanning line selected before or after the selection of the certain scanning line, the high display quality can be realized at a low cost.

According to another aspect of the invention, the scanning line supplementary driving circuit in the electro-optical apparatus driving circuit includes: a supplementary signal supply line that supplies the supplementary signal; a first transistor that connects/disconnects the certain scanning line to/from the supplementary signal supply line; a capacitance element for holding the first transistor in an on state; a second transistor for supplying a voltage that sets the first transistor to an on state and charges the capacitance element based on a scanning signal applied to another scanning line selected prior to the selection of the certain scanning line; and a third transistor for discharging the capacitance element and setting the first transistor to an off state based on a scanning signal applied to another scanning line selected after the selection of the certain scanning line.

According to this aspect of the invention, the scanning line supplementary driving circuit has a simple configuration including the first through third transistors and the capacitance element, and because circuits such as a differentiating circuit, logic circuit, or the like are not necessary, the electro-optical apparatus can be provided at an even lower cost.

According to another aspect of the invention, the capacitance element of the electro-optical apparatus driving circuit is realized by a capacitance element provided separately from the first transistor.

Alternatively, according to another aspect of the invention, the capacitance element of the electro-optical apparatus driving circuit is realized by parasitic capacitance in the first transistor.

According to these aspects of the invention, the capacitance element provided in the scanning line supplementary driving circuit is realized by a capacitance element provided separately from the first transistor or by the parasitic capacitance of the first transistor, and thus whether or not to form the capacitance element can be selected as necessary. In the case where the capacitance element is not formed, the scanning line supplementary driving circuit is realized by the first through third transistors only, and thus in the case where transistor elements such as TFTs are provided for the pixels, those elements can be formed through the same process, making it possible to reduce the manufacturing cost of the electro-optical apparatus.

According to another aspect of the invention, the first, second, and third transistors and the capacitance element of the electro-optical apparatus driving circuit are each provided for each of the multiple rows of scanning lines.

According to another aspect of the invention, the supplementary signal supply line of the electro-optical apparatus driving circuit has: a first supplementary signal supply line, connected via the first transistor to the odd-numbered scanning lines of the multiple rows of scanning lines, that supplies a first supplementary signal whose voltage fluctuates at a cycle that is double the cycle at which the multiple rows of scanning lines are selected; and a second supplementary signal supply line, connected via the first transistor to the even-numbered scanning lines of the multiple rows of scanning lines, that supplies a second supplementary signal whose voltage fluctuates complimentarily with the first supplementary signal.

According to another aspect of the invention, the second transistor of the electro-optical apparatus driving circuit is a diode-connected transistor.

According to another aspect of the invention, the third transistor of the electro-optical apparatus driving circuit is connected to the capacitance element so that the electrodes of the capacitance element are shorted or discharged.

According to another aspect of the invention, the electro-optical apparatus driving circuit further includes: a first voltage supply line, connected to the second transistor, that supplies a voltage for setting the first transistor to an on state and charging the capacitance element; and a second voltage supply line, connected to the third transistor, that supplies a voltage for discharging the capacitance element and setting the first transistor in an off state.

According to another aspect of the invention, the first, second, and third transistors and the capacitance element of the electro-optical apparatus driving circuit are formed in the electro-optical apparatus.

An electro-optical apparatus according to an aspect of the invention includes multiple rows of scanning lines, multiple columns of data lines, and multiple pixels provided corresponding to the locations at which the scanning lines and the data lines intersect. The apparatus includes: a scanning line main driving circuit, provided on at least one end of the multiple rows of scanning lines, that selects the multiple rows of scanning lines in a predetermined order and applies scanning signals thereto; and a scanning line supplementary driving circuit, provided on at least one end of both sides of the multiple scanning lines, that operates in response to a scanning signal being applied by the scanning line main driving circuit to a scanning line selected before or after the selection of a certain scanning line, the scanning line supplementary driving circuit applying a supplementary signal for shaping the waveform of the scanning signal to the certain scanning line during an interval in which the certain scanning line is selected and the scanning signal is applied thereto by the scanning line main driving circuit.

According to this aspect of the invention, when a scanning signal is applied by the scanning line main driving circuit to a certain scanning line among the multiple rows of scanning lines, a supplementary signal for shaping the scanning signal is applied to the certain scanning line by the scanning line supplementary driving circuit, which operates in response to the application of a scanning signal applied to another scanning line selected before or after the selection of the certain scanning line. Accordingly, the occurrence of variance in the brightnesses of pixels, crosstalk, and so on can be prevented, making it possible to realize a high display quality. Furthermore, because the scanning line supplementary driving circuit operates in response to the scanning signal applied to the other scanning line selected before or after the selection of the certain scanning line, the high display quality can be realized at a low cost.

An electronic device according to an aspect of the invention includes the electro-optical apparatus described above.

### BRIEF DESCRIPTION OF THE DRAWINGS

The invention will be described with reference to the accompanying drawings, wherein like numbers reference like elements.

FIG. 1 is a block diagram illustrating the primary configuration of an electro-optical apparatus and a driving circuit thereof according to an embodiment of the invention.

FIG. 2 is a circuit diagram illustrating the primary configuration of a scanning line supplementary driving circuit.

FIG. 3 is a timing chart illustrating operations of the scanning line supplementary driving circuit.

FIG. 4 is a circuit diagram illustrating a first variation on the scanning line supplementary driving circuit.

FIG. 5 is a circuit diagram illustrating a second variation on the scanning line supplementary driving circuit.

FIG. 6 is a block diagram illustrating a first variation on an electro-optical apparatus.

FIGS. 7A and 7B are block diagrams illustrating a second variation on an electro-optical apparatus.

FIG. 8 is an external perspective view illustrating a mobile telephone in which an electro-optical apparatus according to an embodiment of the invention can be applied.

### DESCRIPTION OF EXEMPLARY EMBODIMENTS

Hereinafter, an embodiment of an electro-optical apparatus driving circuit, an electro-optical apparatus, and an electronic device according to the invention will be described in detail with reference to the drawings. Note that the embodiment described hereinafter illustrates only a single aspect of the invention, and is not intended to limit the invention in any way; many variations can be made on the invention without departing from the technical spirit and scope of the invention.

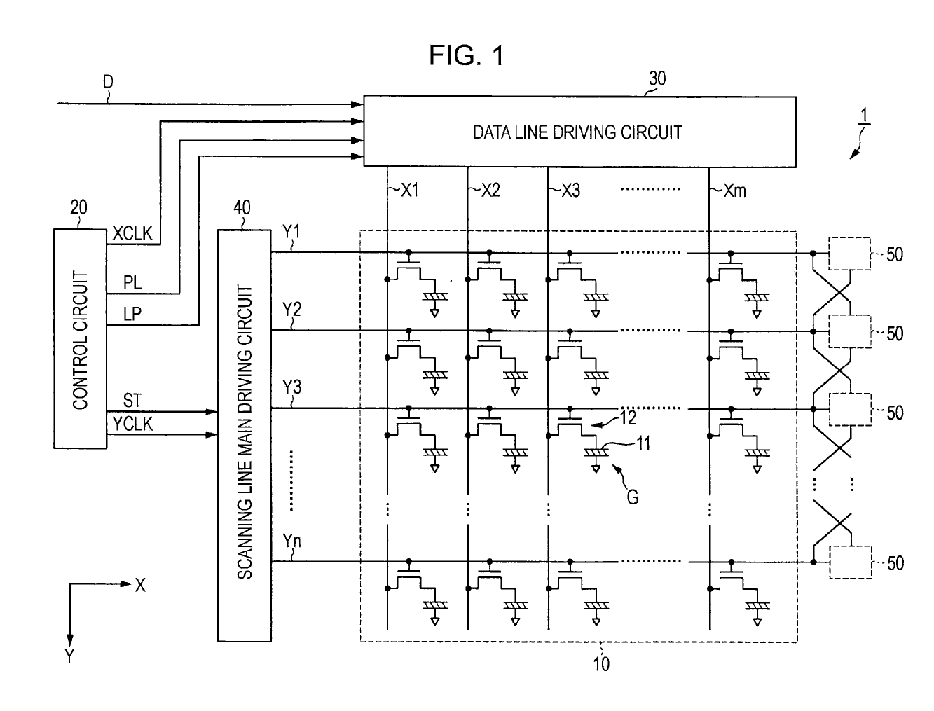

FIG. 1 is a block diagram illustrating the primary configuration of an electro-optical apparatus and a driving circuit thereof according to an embodiment of the invention. Hereinafter, a liquid crystal apparatus will be described as an example of the electro-optical apparatus. As shown in FIG. 1, an electro-optical apparatus 1 according to this embodiment includes a liquid crystal panel 10, a control circuit 20, a data line driving circuit 30, a scanning line main driving circuit 40, and scanning line supplementary driving circuits 50; the data line driving circuit 30, scanning line main driving circuit 40, and scanning line supplementary driving circuits 50 drive the liquid crystal panel 10 under the control of the control circuit 20.

In the liquid crystal panel 10, multiple data lines X1 to Xm (where m is an integer of 2 or more) extending in the Y direction are arranged in the X direction, and multiple scanning lines Y1 to Yn (where n is an integer of 2 or more) extending in the X direction are arranged in the Y direction. Multiple pixels G are formed corresponding to the positions at which the data lines X1 to Xm and the scanning lines Y1 to Yn intersect. Here, a liquid crystal capacitor 11 and a TFT (Thin Film Transistor) 12, which is an example of a switching element, is provided in each pixel G.

The liquid crystal capacitor 11 is structured so that a liquid crystal, which is an example of an electro-optical substance, is held between a rectangular-shaped pixel electrode to which the drain electrode of the TFT 12 is connected and an opposing electrode. The TFT 12 has its gate electrode connected to a scanning line and its source electrode connected to a data line, and the drain electrode thereof is connected to the pixel electrode of the liquid crystal capacitor 11. A selection voltage applied to the scanning line causes the TFT 12 to enter an on state, whereas a data signal supplied from the data line is supplied to the pixel electrode via the TFT 12, thereby changing the optical state of the pixel G. Note that the liquid crystal panel 10 is assumed to employ the normally white mode, whereby the display is white in a state in which no voltage is applied.

The control circuit 20 controls the data line driving circuit 30 and the scanning line main driving circuit 40 so as to drive the liquid crystal panel 10. To be more specific, a latch pulse LP, a polarity specification signal PL, and a data clock signal XCLK are outputted to the data line driving circuit 30, thereby controlling the driving of the data lines X1 to Xm by the data line driving circuit 30, and a start pulse ST and a scanning clock signal YCLK are outputted to the scanning line main driving circuit 40, thereby controlling the driving (scanning) of the scanning lines Y1 to Yn by the scanning line main driving circuit 40.

Here, the stated latch pulse LP is a pulse signal that defines the start of a single horizontal scanning interval. Meanwhile, the stated polarity specification signal PL is a signal that specifies the polarity of the pixel electrode in the liquid crystal capacitor 11. In other words, the polarity specification signal PL is a signal that specifies whether to increase or decrease the potential of the pixel electrode in the liquid crystal capacitor 11 relative to the potential of the opposing electrode. The polarity specification signal PL is a signal for preventing degradation caused by direct-current components being applied to the liquid crystal capacitor 11, and specifies a polarity inversion, for example, every horizontal scanning interval. The stated start pulse ST is a signal indicating that the scanning of the scanning lines Y1 to Yn is to be started, and is a signal that is outputted from the control circuit 20 at the beginning of the vertical scanning interval. Furthermore, the stated scanning clock signal YCLK is a signal that serves as a reference for the scanning timing of the scanning lines Y1 to Yn, and is a signal whose cycle is equivalent to a single horizontal scanning interval.

The data line driving circuit 30 is inputted with the latch pulse LP, polarity specification signal PL, and data clock signal XCLK outputted from the control circuit 20, as well as with tone data D outputted from a host controller (not shown), and outputs data signals based on the tone data D to the data lines X1 to Xm. Note that the tone data D is data specifying tone values (brightnesses) for the pixels G provided in the liquid crystal panel 10.

This tone data D is, for example, 6-bit data, and is thus capable of specifying 64 levels for the tone values of the pixels G, or decimal values from “0” to “63”. This tone data D specifies the darkest black display when its value is, for example, “0” (“000000”, as a binary value), where the tone is specified to increase gradually in brightness as the value of the tone data D increases; thus the tone data D specifies the brightest white display when its value is “63” (“111111”, as a binary value).

To be more specific, the data line driving circuit 30 is provided with a storage region (not shown) that temporarily stores one line's worth of tone data D in accordance with the number of data lines X1 to Xm. When the ith scanning line Yi (where i is an integer fulfilling 1≦i≦n; when i=n+1, i=1) is selected by the scanning line main driving circuit 40, the tone data D of the m pixels G provided corresponding to the ith scanning line is read out and is converted into signals of the polarity specified by the polarity specification signal PL; the resulting signals are supplied all at once to the data lines X1 to Xm as data signals, in synchronization with the latch pulse LP. Along with this, the tone data D of the i+1th row is loaded into the storage region of the data line driving circuit 30 in synchronization with the latch pulse LP and the data clock signal XCLK, in preparation for the selection of the next scanning line Yi+1.

The scanning line main driving circuit 40 is inputted with the start pulse ST and scanning clock signal YCLK outputted from the control circuit 20, and based thereupon, selects the scanning lines Y1 to Yn according to a predetermined order and sequentially outputs scanning signals. Note that the order in which the scanning lines Y1 to Yn are selected is arbitrary; for example, the scanning lines may be selected in order from the scanning line Y1 to the scanning line Yn, or may be selected in order from the scanning line Yn to the scanning line Y1. In this embodiment, to simplify the descriptions, the scanning lines are assumed to be selected in order from the scanning line Y1 to the scanning line Yn.

Specifically, the scanning line main driving circuit 40 collects the start pulses ST supplied from the control circuit 20 at the beginning of a vertical scanning interval (in, for example, an “H (high)” state) in shift registers (not shown) corresponding to the scanning lines Y1 to Yn in synchronization with the scanning clock signal YCLK, and sequentially shifts those pulses. At this time, a scanning line corresponding to a register in the “H” state is called a “selected scanning line”, whereas the remaining scanning lines are called “non-selected scanning lines”; a selection voltage that puts the TFTs 12 of the pixels in that row into an on state is supplied to the selected scanning line, whereas a non-selection voltage that puts the TFTs 12 of the pixels in that row into an off state is supplied to the non-selected scanning lines.

The scanning line supplementary driving circuits 50 are circuits for realizing high display quality in the electro-optical apparatus 1 by applying, to the scanning lines Y1 to Yn, supplementary signals for shaping the scanning signals applied to the scanning lines Y1 to Yn, thereby preventing the occurrence of variance in the brightnesses of the pixels G, crosstalk, and so on. To be more specific, each scanning line supplementary driving circuit 50 operates as a result of a scanning signal being applied, by the scanning line main driving circuit 40, to the scanning lines before and after the ith scanning line Yi is selected (that is, the i−1th scanning line Yi−1 and the i+1th scanning line Yi+1), and in a single horizontal scanning interval in which the ith scanning line Yi is selected and a scanning signal is applied, applies a supplementary signal to the selected ith scanning line Yi.

The scanning line supplementary driving circuits 50 are provided on the side opposite to the scanning line main driving circuit 40, with the scanning lines Y1 to Yn located therebetween. In other words, the scanning line main driving circuit 40 is provided on one end of the scanning lines Y1 to Yn, and the scanning line supplementary driving circuits 50 are provided on the other end of the scanning lines Y1 to Yn. Furthermore, each scanning line supplementary driving circuit 50 is electrically connected to its adjacent scanning lines. For example, the scanning line supplementary driving circuit 50 provided for the ith scanning line Yi is also connected to the i−1th scanning line Yi−1 and the i+1th scanning line Yi+1. Note that although not shown in FIG. 1, the scanning line supplementary driving circuit 50 provided for the first scanning line Y1 may be connected to the nth scanning line Yn, and the scanning line supplementary driving circuit 50 provided for the nth scanning line Yn may be connected to the first scanning line Y1. In addition, dummy scanning lines (not shown) not used for pixels may be provided above the first and below the nth scanning lines, and the scanning line supplementary driving circuit 50 provided for the first scanning line Y1 and the scanning line supplementary driving circuit 50 provided for the nth scanning line Yn may be connected to the respective dummy scanning lines.

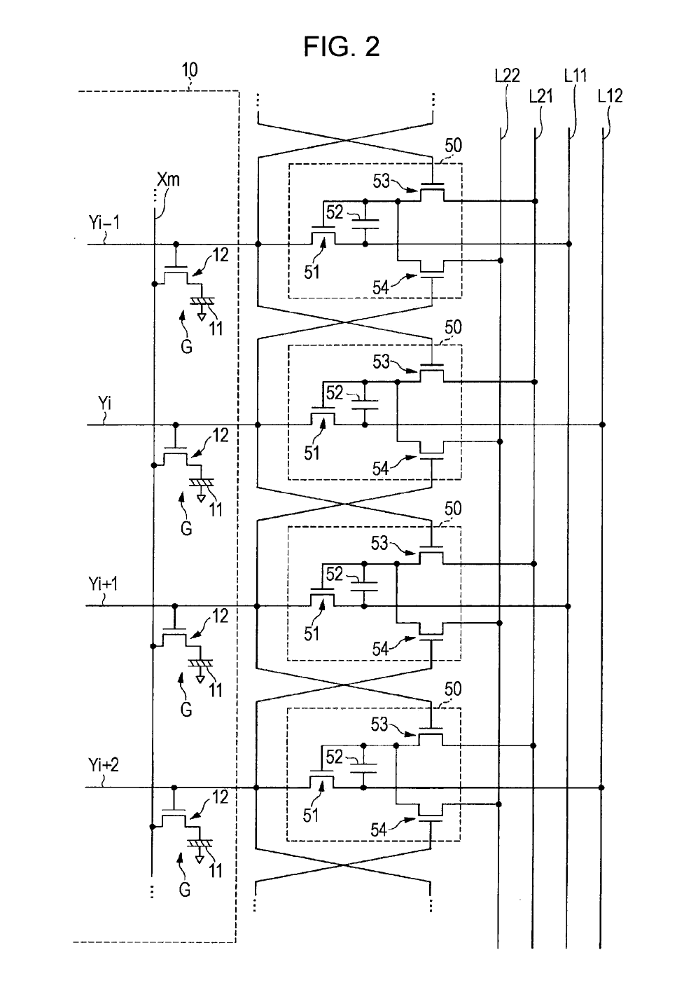

FIG. 2 is a circuit diagram illustrating the primary configuration of the scanning line supplementary driving circuit 50. As shown in FIG. 2, each scanning line supplementary driving circuit 50 includes a transistor 51 (a first transistor), a capacitor 52 (a capacitance element), a transistor 53 (a second transistor), and a transistor 54 (a third transistor). Although not shown in FIG. 1, FIG. 2 shows that the electro-optical apparatus 1 is provided with supplementary signal supply lines L11 and L12 that supply the supplementary signals for shaping the scanning signals applied to the scanning lines Y1 to Yn, and voltage supply lines L21 and L22 that supply voltages for putting the transistor 51 into an on state or an off state.

The stated supplementary signal supply line L11 (first supplementary signal supply line) is connected to the scanning line supplementary driving circuits 50 provided for the odd-numbered scanning lines (for example, the i−1th scanning line Yi−1 and the i+1th scanning line Yi+1), whereas the stated supplementary signal supply line L12 (second supplementary signal supply line) is connected to the scanning line supplementary driving circuits 50 provided for the even-numbered scanning lines (for example, the ith scanning line Yi and the i+2th scanning line Yi+2). Furthermore, each scanning line supplementary driving circuit 50 is connected to both the voltage supply line L21 (first voltage supply line) and the voltage supply line L22 (second voltage supply line).

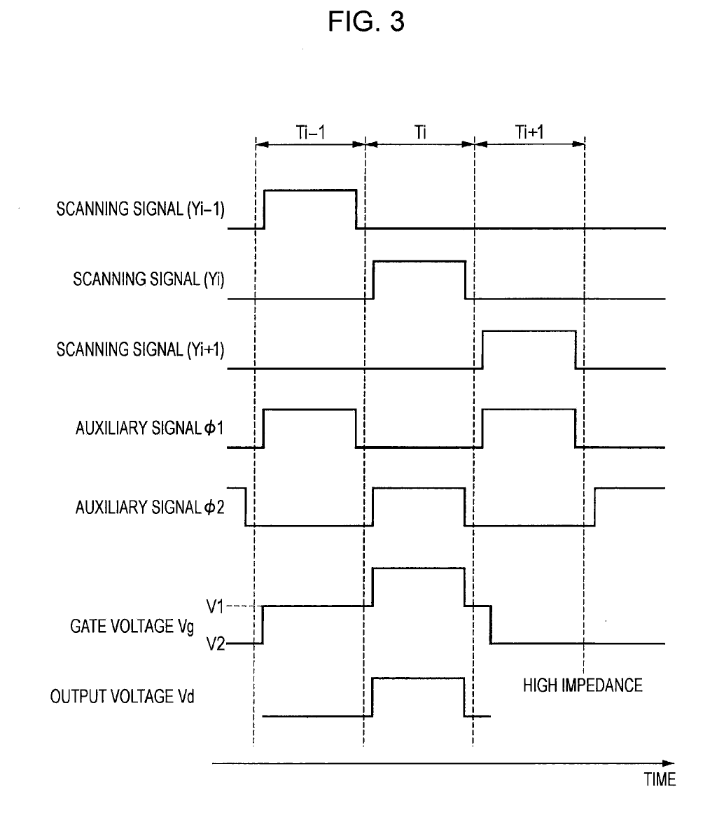

A supplementary signal φ1 supplied via the supplementary signal supply line L11 (first supplementary signal; see FIG. 3) is a signal whose voltage fluctuates over a cycle (one horizontal scanning interval) double the cycle at which the scanning lines Y1 to Yn are selected. Meanwhile, a supplementary signal φ2 supplied via the supplementary signal supply line L12 (second supplementary signal; see FIG. 3) is a signal whose voltage fluctuates complimentarily with the stated supplementary signal φ1 supplied via the supplementary signal supply line L11. In other words, the supplementary signals φ1 and φ2 supplied via the supplementary signal supply lines L11 and L12, respectively, are signals whose levels are inverse relative to each other.

Note that because the scanning line supplementary driving circuits 50 provided for the scanning lines have the same configurations, the scanning line supplementary driving circuit 50 provided for the ith scanning line will be described as a representative example here. The source electrode of the transistor 51 is connected to the supplementary signal supply line L12, and the drain electrode of the transistor 51 is connected to the scanning line Yi; thus a connection between the scanning line Yi and the supplementary signal supply line L12 is established or broken depending on the on/off state of the transistor 51. The supplementary signal φ2 supplied via the supplementary signal supply line L12 is applied to the scanning line Yi as a result of the scanning line Yi and the supplementary signal supply line L12 being connected by the transistor 51, and when the connection between the scanning line Yi and the supplementary signal supply line L12 is released, the application of the supplementary signal φ2 to the scanning line Yi is stopped.

The capacitor 52 is connected between the gate electrode and source electrode of the transistor 51. The capacitor 52 is provided in order to hold the transistor 51 in an on state. In other words, when the capacitor 52 is charged, the voltage applied to the gate electrode of the transistor 51 is held above a gate threshold voltage, resulting in the transistor 51 being held in the on state. The capacitor 52 is realized by an element (capacitance element) formed separately from the transistor 51. Note that in the case where parasitic capacitance of a degree that allows the transistor 51 to be held in the on state is present in the transistor 51, the capacitor 52 can be realized by the parasitic capacitance of the transistor 51 without forming a capacitance element separate from the transistor 51.

The source electrode of the transistor 53 is connected to the voltage supply line L21; the drain electrode of the transistor 53 is connected to the gate electrode of the transistor 51 and one of the electrodes of the capacitor 52; and the gate electrode of the transistor 53 is connected to the i−1th scanning line Yi−1. The transistor 53 enters an on state due to the scanning signal applied to the i−1th scanning line Yi−1, and supplies a voltage V1 (a voltage for putting the transistor 51 in an on state), supplied via the voltage supply line L21, to the gate electrode of the transistor 51 and the capacitor 52. Note that the transistor 51 is held in the on state by the voltage V1 supplied via the voltage supply line L21 being supplied to the capacitor 52.

The source electrode of the transistor 54 is connected to the voltage supply line L22; the drain electrode of the transistor 54 is connected to the gate electrode of the transistor 51, the drain electrode of the transistor 53, and one of the electrodes of the capacitor 52; and the gate electrode of the transistor 54 is connected to the i+1th scanning line Yi+1. The transistor 54 enters an on state due to the scanning signal applied to the i+1th scanning line Yi+1, and supplies a voltage V2 (a voltage for putting the transistor 51 in an off state), supplied via the voltage supply line L22, to the gate electrode of the transistor 51 and the capacitor 52. Note that the transistor 51 enters the off state and the capacitor 52 is discharged as a result of the supply of the voltage V2 supplied via the voltage supply line L22.

Note that because the ith scanning line Yi is an even-numbered scanning line, the source electrode of the transistor 51 is connected to the supplementary signal supply line L12, as described above. Such is the case for the other even-numbered scanning line (the i+2th scanning line Yi+2) as well. On the other hand, the source electrodes of the transistors 51 in the scanning line supplementary driving circuits 50 provided for the odd-numbered scanning lines (for example, the i−1th scanning line Yi−1 and the i+1th scanning line Yi+1) are connected to the supplementary signal supply line L11.

The transistors 51, 53, and 54 provided in the scanning line supplementary driving circuit 50 described above can be realized through the same structure as the TFT 12 provided in the liquid crystal panel 10. Furthermore, in the case where the capacitor 52 is realized by parasitic capacitance in the transistor 51, forming the capacitor 52 is unnecessary. Accordingly, the scanning line supplementary driving circuits 50 can be formed in the liquid crystal panel 10 along with the TFTs 12 and so on, without allocating a new process for forming the scanning line supplementary driving circuits 50. It is thus not necessary to provide the scanning line supplementary driving circuits 50 outside of the liquid crystal panel 10, enabling the electro-optical apparatus to be manufactured at a low cost.

Next, operations of the electro-optical apparatus 1 configured as described above when the liquid crystal panel 10 thereof is being driven will be described. The driving of the liquid crystal panel 10 commences when the tone data D is outputted from a host controller (not shown) and the latch pulse LP, polarity specification signal PL, start pulses ST, scanning clock signal YCLK, and data clock signal XCLK are outputted from the control circuit 20. The tone data D outputted from the host controller (not shown) is temporarily stored in the storage region provided in the data line driving circuit 30.

The start pulses ST and scanning clock signal YCLK outputted from the control circuit 20 are inputted into the scanning line main driving circuit 40. The scanning line main driving circuit 40 loads the start pulses ST outputted from the control circuit 20 at the rise of the scanning clock signal YCLK and sequentially shifts the start pulses ST, in correspondence with the selections of the scanning lines Y1 to Yn. Upon doing so, first, the scanning line Y1 is selected, and a selection voltage is applied. Accordingly, the m TFTs 12 connected to the scanning line Y1 enter an on state.

Meanwhile, the latch pulse LP, polarity specification signal PL, and data clock signal XCLK outputted from the control circuit 20 are inputted into the data line driving circuit 30. Based on the inputted latch pulse LP, the data line driving circuit 30 reads out the tone data D of the m pixels G provided in correspondence with the first scanning line Y1 from the storage region (not shown), converts the data to signals of the polarity specified by the polarity specification signal PL, and supplies those signals all at once to the data lines X1 to Xm as data signals. Upon doing so, the data signals supplied via the data lines X1 to Xm are supplied to the m pixel electrodes provided in correspondence with the scanning line Y1 via the m TFTs 12 connected to the scanning line Y1. Accordingly, the optical states of the m pixels provided in correspondence with the scanning line Y1 change based on the supplied data signals.

When the aforementioned operations end, the next scanning line Y2 is selected by the scanning line main driving circuit 40, and the tone data D of the m pixels G provided in correspondence with the second scanning line Y2 are read out by the data line driving circuit 30, data signals are created, and the data signals are supplied all at once to the data lines X1 to Xm. Accordingly, the optical states of the m pixels provided in correspondence with the scanning line Y2 change based on the supplied data signals. Similar operations as these are then repeated, whereby the other scanning lines Y3 to Yn are sequentially selected and data signals are supplied thereto; as a result, an image based on a single screen's worth of tone data D is displayed in the liquid crystal panel 10. While the scanning line Yn is selected, the host controller outputs the first line's worth of tone data D for the next screen, after which the selection of the scanning lines Y1 to Yn is once again carried out sequentially, and the next image is displayed in the liquid crystal panel 10.

Next, operations performed by the scanning line supplementary driving circuit 50 while the aforementioned operations are being performed will be described in detail. FIG. 3 is a timing chart illustrating operations of the scanning line supplementary driving circuit 50. Here, to facilitate understanding, descriptions will be given focusing on the scanning line supplementary driving circuit 50 provided for the ith scanning line Yi. As shown in FIG. 3, in the case where the scanning lines Y1 to Yn are selected in order from the scanning line Y1 to the scanning line Yn as described above, a scanning signal is applied to the i−1th scanning line Yi−1 in the interval Ti−1, a scanning signal is applied to the ith scanning line Yi in the following interval Ti, and a scanning signal is applied to the i+1th scanning line Yi+1 in the interval Ti+1 that follows thereafter.

When the scanning signal is applied to the scanning line Yi−1 in the interval Ti−1, the transistor 53 in the scanning line supplementary driving circuit 50 provided for the scanning line Yi enters an on state, and the voltage V1 supplied via the voltage supply line L21 is supplied to the gate electrode of the transistor 51 and the capacitor 52. Upon doing so, the voltage at the gate electrode of the transistor 51 in the scanning line supplementary driving circuit 50 provided for the scanning line Yi (a gate voltage Vg, shown in FIG. 3) becomes the voltage V1, and the transistor 51 enters an on state. Meanwhile, the capacitor 52 in the scanning line supplementary driving circuit 50 provided for the scanning line Yi is charged to the voltage V1, and the transistor 51 is held in the on state.

When the transistor 51 enters the on state, the scanning line Yi and the supplementary signal supply line L12 are in an electrically-connected state, and thus the supplementary signal φ2 supplied via the supplementary signal supply line L12 is applied to the scanning line Yi. Here, as shown in FIG. 3, because the supplementary signal φ2 supplied via the supplementary signal supply line L12 in the interval Ti−1 is “L (low)” level, a problem whereby the scanning line Yi−1 and the scanning line Yi are selected at the same time does not occur.

When the interval Ti−1 ends and the interval Ti begins, the transistor 53 in the scanning line supplementary driving circuit 50 provided for the scanning line Yi enters an off state, but the transistor 51 is held in the on state. Meanwhile, upon entering the interval Ti, a scanning signal is applied to the scanning line Yi, and at the same time, the supplementary signal φ2 supplied via the supplementary signal supply line L12 goes to the “H” level. Upon doing so, the H level supplementary signal φ2 is outputted from the drain electrode of the transistor 51 and applied to the scanning line Yi (see the “output voltage Vd” in FIG. 3). Accordingly, even if the waveform of the scanning signal applied to the scanning line Yi by the scanning line main driving circuit 40 is dulled, that dulling can be corrected. Note that as shown in FIG. 3, the gate voltage Vg of the transistor 51 rises beyond the voltage V1 for the interval in which the supplementary signal φ2 is at the H level.

When the interval Ti end and the interval Ti+1 begins, a scanning signal is applied to the scanning line Yi+1, and the transistor 54 in the scanning line supplementary driving circuit 50 for the scanning line Yi enters an on state; the voltage V2 supplied via the voltage supply line L22 is then supplied to the gate electrode of the transistor 51 and the capacitor 52. Upon doing so, the gate voltage Vg at the transistor 51 in the scanning line supplementary driving circuit 50 provided for the scanning line Yi becomes the voltage V2, as shown in FIG. 3; the transistor 51 enters an off state, resulting in a high impedance, as shown in FIG. 3. At the same time, the capacitor 52 in the scanning line supplementary driving circuit 50 provided for the scanning line Yi is discharged. Accordingly, the connection between the scanning line Yi and the supplementary signal supply line L12 is released, and the application of the supplementary signal φ2 to the scanning line Yi is stopped.

In addition to the scanning line supplementary driving circuit 50 provided for the scanning line Yi, the same operations as those described thus far are carried out for the scanning line supplementary driving circuits 50 provided for the other scanning lines. Accordingly, dulling of the scanning signal applied to the scanning lines Y1 to Yn by the scanning line main driving circuit 40 can be corrected, thereby making it possible to realize a higher-quality display.

As described thus far, according to this embodiment, scanning line supplementary driving circuits 50 are provided for each scanning line, each scanning line supplementary driving circuit 50 operating as a result of a scanning signal being applied to the scanning lines before and after a certain scanning line (for example, the scanning line Yi) is selected (for example, the scanning lines Yi−1 and Yi+1), and applying a supplementary signal for shaping the scanning signal to that scanning line (for example, the scanning line Yi) during the interval in which the scanning signal is applied to that scanning line (for example, the scanning line Yi). Accordingly, providing a differentiating circuit, a logical circuit, and the like, as with past electro-optical apparatuses, is unnecessary, making it possible to realize higher display qualities at lower costs.

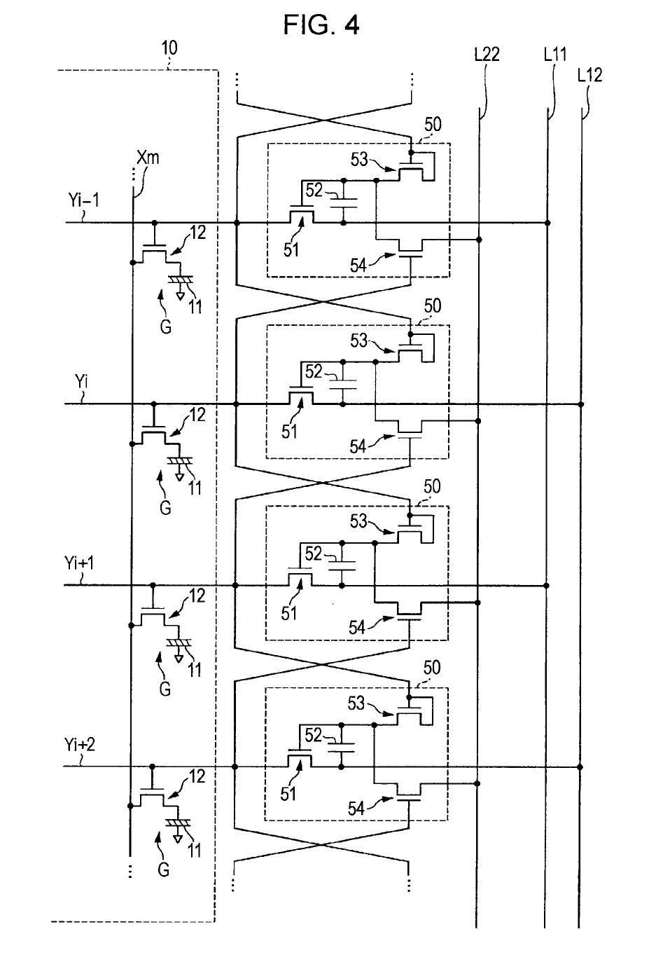

FIG. 4 is a circuit diagram illustrating a first variation on the scanning line supplementary driving circuit 50. As shown in FIG. 4, the scanning line supplementary driving circuit 50 according to this variation is configured so as to include a diode-connected transistor 53. By employing this configuration, the voltage supply line L21 that supplies the voltage V1 for putting the transistor 51 into the on state can be omitted. The source electrode and gate electrode of each transistor 53 provided in the scanning line supplementary driving circuits 50 are shorted, with the connection being realized by a diode.

In the case where the scanning line supplementary driving circuits 50 are configured as illustrated in FIG. 2, changing the voltages of the voltages V1 and V2 supplied by the voltage supply lines L21 and L22 can be applied regardless of whether the scanning direction in which the scanning line main driving circuit 40 scans the scanning lines Y1 to Yn is the direction moving toward the scanning line Yn from the scanning line Y1 or the direction moving from the scanning line Yn toward the scanning line Y1. As opposed to this, in the case where the scanning line supplementary driving circuits 50 are configured as illustrated in FIG. 4, the scanning direction of the scanning lines Y1 to Yn is limited to a single direction, but the voltage supply line L21 can be omitted.

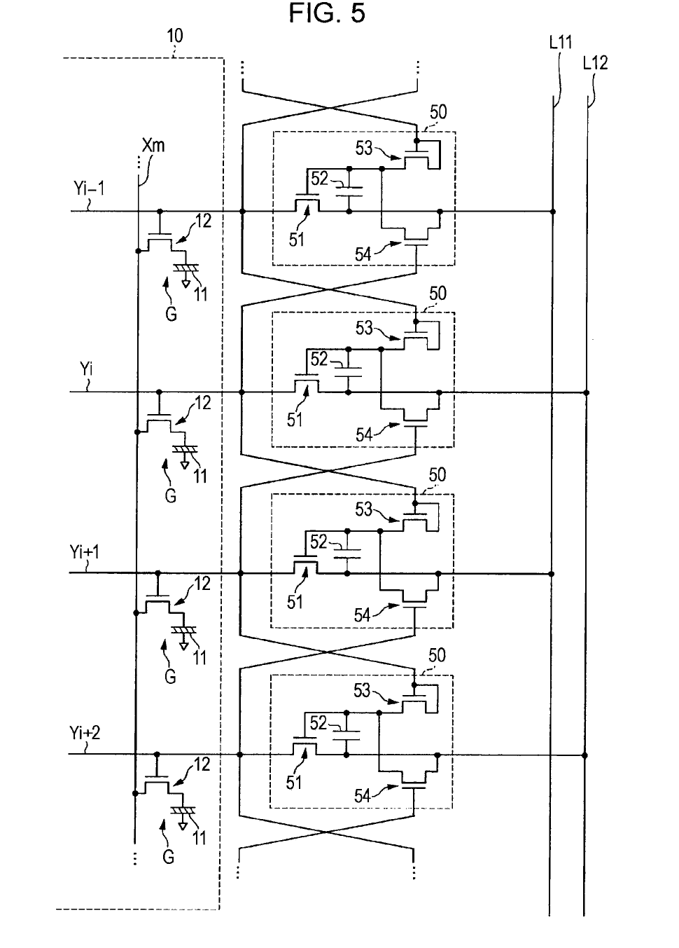

FIG. 5 is a circuit diagram illustrating a second variation on the scanning line supplementary driving circuit 50. As shown in FIG. 5, the scanning line supplementary driving circuit 50 according to this variation includes a diode-connected transistor 53, as with the aforementioned first variation, but the configuration is such that the source electrode of the transistor 54 is connected to the other electrode of the capacitor 52. By employing this configuration, the voltage supply line L22 that supplies the voltage V2 for putting the transistor 51 into the off state can be omitted. Note that because the drain electrode of the transistor 54 is connected to one electrode of the capacitor 52, the electrodes of the capacitor 52 are shorted or discharged by putting the transistor 54 into the on state or the off state.

As with the aforementioned first variation, the scanning direction of the scanning lines Y1 to Yn is limited to either the direction moving toward the scanning line Yn from the scanning line Y1 or the direction moving from the scanning line Yn toward the scanning line Y1 in this variation as well. However, in this variation, the voltage supply line L22 can be omitted in addition to the voltage supply line L21 thereabove. Note that the scanning line supplementary driving circuits 50 can be formed in the liquid crystal panel 10 along with the TFTs 12 and so on in the aforementioned first and second variations as well.

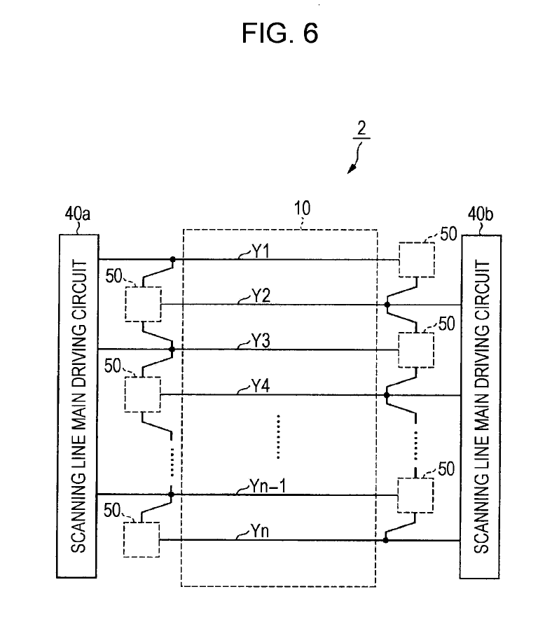

FIG. 6 is a block diagram illustrating a first variation on the electro-optical apparatus. As shown in FIG. 6, an electro-optical apparatus 2 according to this variation includes a scanning line main driving circuit 40a disposed on one end of the scanning lines Y1 to Yn and connected to the odd-numbered scanning lines (Y1, Y3, and so on), and a scanning line main driving circuit 40b disposed on the other end of the scanning lines Y1 to Yn and connected to the even-numbered scanning lines (Y2, Y4, and so on). Note that in FIG. 6, the control circuit 20, data line driving circuit 30, and supplementary signal supply lines L11 and L12 have been omitted from the drawing for the sake of simplicity.

While the electro-optical apparatus 2 according to this variation includes scanning line supplementary driving circuits 50 provided for each of the scanning lines Y1 to Yn in the same manner as the electro-optical apparatus 1 illustrated in FIG. 1, scanning line supplementary driving circuits 50 provided for the odd-numbered scanning lines are disposed on one end of the scanning lines, and scanning line supplementary driving circuits 50 provided for the even-numbered scanning lines are disposed on the other end of the scanning lines. Note that the supplementary signal supply lines L11 and L12 shown in FIG. 2 and the voltage supply lines L21 and L22 are respectively provided on the ends of the scanning lines Y1 to Yn.

Aside from the scanning lines Y1 to Yn being selected by the two scanning line main driving circuits 40a and 40b, the operations of the electro-optical apparatus 2 configured in this manner are basically the same as the operations of the electro-optical apparatus 1 illustrated in FIG. 1, and supplementary signals are applied to the scanning lines Y1 to Yn by the scanning line supplementary driving circuits 50. The electro-optical apparatus 2 according to this variation has a smaller space between the scanning lines Y1 to Yn, and is suited to cases where it is difficult to form the scanning line supplementary driving circuits 50 on one side only of the scanning lines Y1 to Yn, as with the electro-optical apparatus 1 shown in FIG. 1.

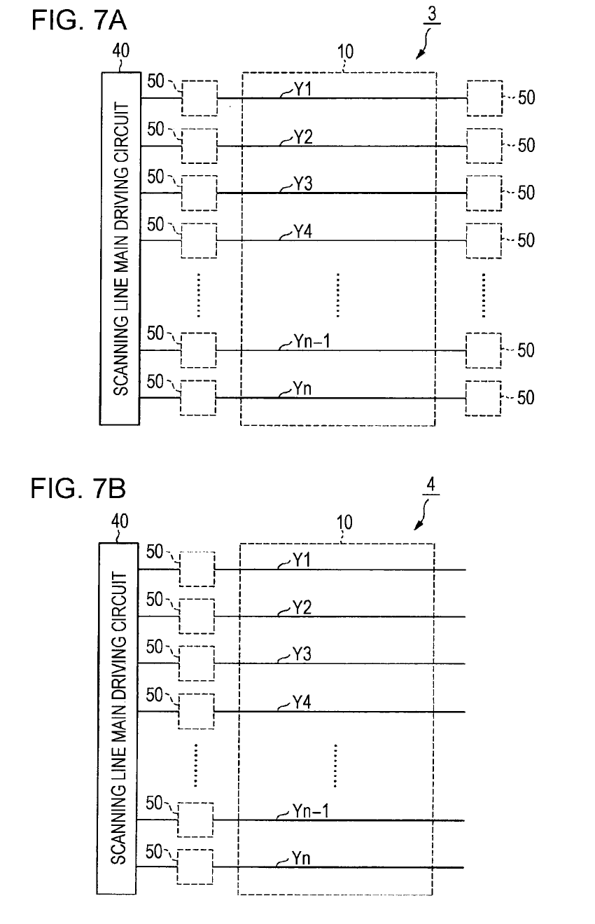

FIGS. 7A and 7B are block diagrams illustrating a second variation on the electro-optical apparatus. A electro-optical apparatus 3 shown in FIG. 7A differs from the electro-optical apparatus 1 shown in FIG. 1 in that a scanning line supplementary driving circuit 50 is provided on both sides of each scanning line Y1 to Yn. As with the electro-optical apparatus 2 shown in FIG. 6, the supplementary signal supply lines L11 and L12 shown in FIG. 2 and the voltage supply lines L21 and L22 are respectively provided on the ends of the scanning lines Y1 to Yn in this electro-optical apparatus 3 as well.

Note that in FIG. 7, the control circuit 20, data line driving circuit 30, and supplementary signal supply lines L11 and L12, as well as the connection lines connecting the scanning line supplementary driving circuits 50 to their adjacent scanning lines, have been omitted from the drawing for the sake of simplicity. By employing such a configuration, the output resistance of the scanning line main driving circuit 40 may be high, and thus the scale of the scanning line main driving circuit 40 can be reduced. If the only desire is to reduce the scale of the scanning line main driving circuit 40, a configuration in which the scanning line supplementary driving circuits 50, the voltage supply lines L21 and L22, and so on on one side of the scanning lines Y1 to Yn have been omitted is conceivable as well, as exemplified by a electro-optical apparatus 4 shown in FIG. 7B.

While an electro-optical apparatus and a driving circuit thereof according to an embodiment of the invention have been described thus far, the invention is not limited to the aforementioned embodiments, and changes can be freely made thereto without departing from the scope of the invention. For example, while the liquid crystal panel 10 is described in the aforementioned embodiment as employing the normally white mode, whereby the display is white in a state in which no voltage is applied, the liquid crystal panel 10 may employ the normally black mode, whereby the display is black in a state in which no voltage is applied. Note also that the number of tones is not limited to 64, and the display may include a lower number of tones or a higher number of tones. Furthermore, a color display, in which three pixels, or R (red), G (green), and B (blue) configure a single dot, may be employed as well.

The liquid crystal panel 10 is not limited to a transmissive type, and a reflective type or a semi-transmissive, semi-reflective type may be employed as well. Furthermore, although the embodiment describes an active matrix system whereby pixel electrodes are driven by switching elements such as the TFTs 12, the dulling of the waveform of the scanning signals occurs in the same manner in passive matrix displays as well, and thus the invention can be applied to the passive matrix system as well. Furthermore, the TFT 12 is merely an example of the switching element, and elements employing a ZnO (zinc oxide) varistor, an MSI (metal semi-insulator), serial or parallel connections in which two such elements are inversely disposed, or a one terminal pair-type switching element such as a TFD (thin-film diode) may be used in place of the TFT 12.

In addition, the following may be used as the liquid crystal of the liquid crystal panel 10: a TN-type liquid crystal; an STN-type liquid crystal; a guest-host type liquid crystal in which a dye having anisotropy with respect to the absorption of visible light in the long and short axial directions (the “guest”) is dissolved into a liquid crystal having a constant molecular arrangement (the “host”), thereby arranging the dye molecules and liquid crystal molecules in parallel; or the like. In addition, the configuration may provide a vertical alignment type liquid crystal (homeotropic alignment) in which the liquid crystal molecules are aligned vertically relative to the substrates when no voltage is applied but are aligned horizontally relative to the substrates when a voltage is applied, or may provide a parallel (horizontal) alignment type liquid crystal (homogeneous alignment) in which the liquid crystal molecules are aligned horizontally relative to the substrates when no voltage is applied but are aligned vertically relative to the substrates when a voltage is applied.

Furthermore, the electro-optical apparatus according to the invention is not limited to a liquid crystal apparatus, and can be applied in other electro-optical apparatuses, such as organic EL apparatuses, inorganic EL apparatuses, plasma display apparatuses, electrophoretic display apparatuses, field emission display apparatuses, LEDs, electronic papers (with electronic papers employing electrophoretic elements being a representative example), and so on. In this manner, the invention can be employed in a variety of electro-optical elements as long as those elements are compatible with the driving method of the invention. Furthermore, the invention can also be applied in a two-dimensional sensor configured of an active matrix.

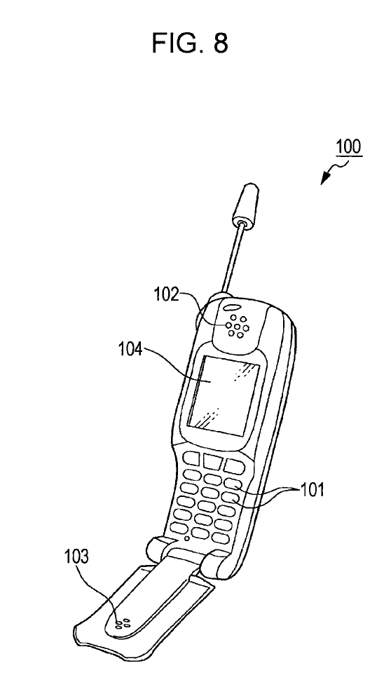

Next, an electronic device provided with the electro-optical apparatus according to the above embodiment as its display device will be described. FIG. 8 is an external perspective view illustrating a mobile telephone 100 in which the electro-optical apparatus according to an embodiment of the invention can be applied. As shown in FIG. 8, the mobile telephone 100 includes multiple operation buttons 101, a receiver opening 102, and a transmitter opening 103, as well as the liquid crystal panel 10, which serves as a display device 104. Note that of the electro-optical apparatus, the constituent elements aside from the liquid crystal panel 10 are confined within the mobile telephone 100 and thus do not appear on the outside of the mobile telephone 100.

In addition to the mobile telephone 100 shown in FIG. 8, a digital still camera, a laptop computer, an LCD television, a viewfinder-type (or monitor direct-view type) video recorder, a car navigation device, a pager, a PDA, a calculator, a word processor, a workstation, a videophone, a POS terminal, a device including a touch panel, and so on can be given as examples of electronic devices in which the electro-optical apparatus can be applied. It goes without saying that the aforementioned electro-optical apparatus can be applied as the display device of these various electronic devices. Correcting the dulling of the scanning signal waveforms makes it possible to realize a configuration in which a drop in the display quality is suppressed and a high-quality display can easily be achieved, in any of these electronic devices.

The entire disclosure of Japanese Patent Application No. 2009-074179, filed Mar. 25, 2009 is expressly incorporated by reference herein.

What is claimed is:

1. An electro-optical apparatus driving circuit that drives an electro-optical apparatus including multiple rows of scanning lines, multiple columns of data lines, and multiple pixels provided corresponding to the locations at which the scanning lines and the data lines intersect, the driving circuit comprising:
a scanning line main driving circuit, provided on at least one end of the multiple rows of scanning lines, that selects the multiple rows of scanning lines in a predetermined order and applies scanning signals thereto; and
a scanning line supplementary driving circuit, provided on at least one end of the both ends of the multiple scanning lines, that operates in response to a scanning signal being applied by the scanning line main driving circuit to a scanning line selected before or after the selection of a certain scanning line, the scanning line supplementary driving circuit applying a supplementary signal for shaping the waveform of the scanning signal to the certain scanning line during an interval in which the certain scanning line is selected and the scanning signal is applied thereto by the scanning line main driving circuit.

2. The electro-optical apparatus driving circuit according to claim 1,
wherein the scanning line supplementary driving circuit includes:
a supplementary signal supply line that supplies the supplementary signal;
a first transistor that connects/disconnects the certain scanning line to/from the supplementary signal supply line;
a capacitance element for holding the first transistor in an on state;
a second transistor for supplying a voltage that sets the first transistor to an on state and charges the capacitance element based on a scanning signal applied to another scanning line selected prior to the selection of the certain scanning line; and
a third transistor for discharging the capacitance element and setting the first transistor to an off state based on a scanning signal applied to another scanning line selected after the selection of the certain scanning line.

3. The electro-optical apparatus driving circuit according to claim 2, wherein the capacitance element is realized by a capacitance element provided separately from the first transistor.

4. The electro-optical apparatus driving circuit according to claim 2, wherein the capacitance element is realized by parasitic capacitance in the first transistor.

5. The electro-optical apparatus driving circuit according to claim 2, wherein the first, second, and third transistors and the capacitance element are each provided for each of the multiple rows of scanning lines.

6. The electro-optical apparatus driving circuit according to claim 5,
wherein the supplementary signal supply line has:
a first supplementary signal supply line, connected via the first transistor to the odd-numbered scanning lines of the multiple rows of scanning lines, that supplies a first supplementary signal whose voltage fluctuates at a cycle that is double the cycle at which the multiple rows of scanning lines are selected; and
a second supplementary signal supply line, connected via the first transistor to the even-numbered scanning lines of the multiple rows of scanning lines, that supplies a second supplementary signal whose voltage fluctuates complimentarily with the first supplementary signal.

7. The electro-optical apparatus driving circuit according to claim 2, wherein the second transistor is a diode-connected transistor.

8. The electro-optical apparatus driving circuit according to claim 2, wherein the third transistor is connected to the capacitance element so that the electrodes of the capacitance element are shorted or discharged.

9. The electro-optical apparatus driving circuit according to claim 6, further comprising:
a first voltage supply line, connected to the second transistor, that supplies a voltage for setting the first transistor to an on state and charging the capacitance element; and
a second voltage supply line, connected to the third transistor, that supplies a voltage for discharging the capacitance element and setting the first transistor in an off state.

10. The electro-optical apparatus driving circuit according to claim 1, wherein the first, second, and third transistors and the capacitance element are formed in the electro-optical apparatus.

11. An electro-optical apparatus including multiple rows of scanning lines, multiple columns of data lines, and multiple pixels provided corresponding to the locations at which the scanning lines and the data lines intersect, the apparatus comprising:
a scanning line main driving circuit, provided on at least one end of the multiple rows of scanning lines, that selects the multiple rows of scanning lines in a predetermined order and applies scanning signals thereto; and
a scanning line supplementary driving circuit, provided on at least one end of both sides of the multiple scanning lines, that operates in response to a scanning signal being applied by the scanning line main driving circuit to a scanning line selected before or after the selection of a certain scanning line, the scanning line supplementary driving circuit applying a supplementary signal for shaping the waveform of the scanning signal to the certain scanning line during an interval in which the certain scanning line is selected and the scanning signal is applied thereto by the scanning line main driving circuit.

12. An electronic device comprising the electro-optical apparatus according to claim 11.
